(19) United States
(12) Patent Application Publication
(10) Pub. No.: US 2025/0308137 A1
(43) Pub. Date: Oct. 2, 2025

(54) DISTILLING NEURAL RADIANCE FIELDS INTO SPARSE HIERARCHICAL VOXEL MODELS FOR GENERALIZABLE SCENE REPRESENTATION PREDICTION

(71) Applicant: NVIDIA CORPORATION, Santa Clara, CA (US)

(72) Inventors: Peter KARKUS, Zurich (CH); Letian WANG, North York (CA); Cunjun YU, Singapore (SG); Boris IVANOVIC, Mountain View, CA (US); Yue WANG, Los Angeles, CA (US); Sanja FIDLER, Toronto (CA); Marco PAVONE, Stanford, CA (US); Seung Wook KIM, Seoul (KR)

(21) Appl. No.: 18/979,444

(22) Filed: Dec. 12, 2024

Related U.S. Application Data
(60) Provisional application No. 63/573,203, filed on Apr. 2, 2024.

(51) Int. Cl. G06T 15/06; G06T 3/4046; G06T 9/40; G06T 15/20; G06T 15/50

(52) U.S. Cl. CPC G06T 15/06; G06T 3/4046; G06T 9/40; G06T 15/20; G06T 15/506; G06T 2210/36

(57) ABSTRACT

At least one embodiment is directed towards a computer-implemented method for generating generalized scene representations. The computer-implemented method includes extracting feature information from a plurality of scene images, encoding the feature information to generate a plurality of feature images, and estimating depths of at least a plurality of pixels in each feature image included in the plurality of feature images to produce a plurality of feature frustra. The computer-implemented method also includes generating a plurality of octree voxels from the plurality of feature frusta, sampling points along a plurality of views from different proposed camera angles relative to the plurality of octree voxels to produce feature angles and depths that are subsequently aggregated into a plurality of predicted feature maps, and decoding the plurality of predicted feature maps to generate a plurality of final features maps.

### CROSS-REFERENCE TO RELATED APPLICATIONS

This application claims benefit of the U.S. Provisional Patent Application titled “DISTILLING NEURAL RADIANCE FIELDS INTO SPARSE HIERARCHICAL VOXEL MODELS FOR GENERALIZABLE SCENE REPRESENTATION,” filed Apr. 2, 2024, and having Ser. No. 63/573,203. The subject matter of this related application is hereby incorporated herein by reference.

### BACKGROUND

### Field of the Various Embodiments

The various embodiments relate generally to computer science, computer vision, and machine learning and, more specifically, predicting generalized scene representations by distilling neural radiance fields into sparse octree voxel models.

### Description of the Related Art

Computer scientists and engineers are interested in constructing three-dimensional (“3D”) representations of real-world scenes from two-dimensional (“2D”) images for a variety of different applications. For example, 3D representations of a scene constructed from 2D images enable rotated or transformed images of the scene to be generated efficiently, without requiring additional images of the scene or other information. Additionally, 3D representations of scenes enable the movements and interactions of objects within the scenes to be modeled. For example, a 3D representation of a scene constructed from a 2D image can be used to identify the objects within the scene that are near or far from the observer and/or the objects within the scene that are potentially in the path of the observer. One of the more compelling applications of 3D representations of scenes is in autonomous machine control and, specifically, in autonomous driving. For example, for computer systems to control vehicles and other machines autonomously, a 3D model of the scene surrounding a given vehicle or machine being controlled is usually required.

One technique for constructing 3D representations of scenes is referred to as the “high-fidelity” approach. With this type of technique, a model is trained on many images taken from a single scene. During training, the model learns detailed representations of the single scene. The resulting trained model can then be used to generate new, high-fidelity images of the single scene from arbitrary angles. Techniques such as Neural Radiance Fields (NeRF) and 3D Gaussian Splatting (3DGS) are examples of the high-fidelity approach. One drawback of the high-fidelity approach, however, is that a model trained using this technique is limited to a single scene and cannot be used for different or more general 3D scene representations. Additionally, a trained high-fidelity model can be both computationally large and slow to operate, which impedes the use of these models in autonomous machine control.

Another technique for constructing 3D representations of scenes is the “one-shot” approach. This technique attempts to overcome the single-scene limitation of the high-fidelity approach. In the one-shot approach, a general model for placing the objects appearing within various 2D images into a 3D representation is first learned. Then, a ray from a proposed viewing angle is projected through the learned 3D representation, and any objects along the path of the ray are subsequently processed into a new 2D image. PixelNerf, NeuRay, and NeuralFieldLDM are examples of the of the one-shot approach.

One drawback of the one-shot approach is insufficient accuracy. Tasks such as autonomous driving require high degrees of accuracy in generating arbitrary scene representations in order to be implemented safely. Current techniques have yet to reach an acceptable accuracy level, especially in outdoor scenes, which limits the effectiveness and usefulness of the one-shot approach. Another drawback of the one-shot approach is insufficient training data. A natural avenue for improving model accuracy is by training a model on a larger volume of data. However, training models to represent 3D scenes requires very expensive training data, including images from multiple viewing angles along with 3D location information for many different scenes. Accordingly, improving the accuracy of a model generated using the one-shot approach through enhanced or additional training is difficult.

As the foregoing illustrates, what is needed in the art are more effective ways to generate 3D representations of scenes.

### SUMMARY

At least one embodiment is directed towards a computer-implemented method for generating generalized scene representations. The computer-implemented method includes extracting feature information from a plurality of scene images, encoding the feature information to generate a plurality of feature images, and estimating a depth of each pixel in each feature image included in the plurality of feature images to produce a plurality of feature frustra. The computer-implemented method also includes generating a plurality of octree voxels from the plurality of feature frusta, sampling points along a plurality of views from different proposed camera angles relative to the plurality of octree voxels to produce feature angles and depths that are subsequently aggregated into a plurality of predicted feature maps, and decoding the plurality of predicted feature maps to generate a plurality of final features maps.

At least one technical advantage of the disclosed techniques relative to the prior art is that the disclosed techniques achieve high levels of general scene reconstruction accuracy while maintaining computational efficiency. Accordingly, the disclosed techniques enable 3D reconstruction of scenes to be implemented in real-time or near real-time in autonomous vehicle control settings. Another technical advantage of the disclosed techniques is the more efficient utilization of 2D training data via distillation from pre-trained NeRF models. As a result, with the disclosed techniques, substantially less training data is needed to achieve required levels of accuracy for 3D reconstruction of scenes. These technical advantages provide one or more technological advances over prior art approaches.

### BRIEF DESCRIPTION OF THE DRAWINGS

So that the manner in which the above recited features of the various embodiments can be understood in detail, a more particular description of the inventive concepts, briefly summarized above, may be had by reference to various embodiments, some of which are illustrated in the appended drawings. It is to be noted, however, that the appended drawings illustrate only typical embodiments of the inventive concepts and are therefore not to be considered limiting of scope in any way, and that there are other equally effective embodiments.

FIG. 1 illustrates a block diagram of a computer-based system configured to implement one or more aspects of the various embodiments;

FIG. 2 is a block diagram illustrating the machine learning server of FIG. 1 in greater detail, according to various embodiments;

FIG. 3 is a block diagram illustrating the computing device of FIG. 1 in greater detail, according to various embodiments;

FIG. 4 is a more detailed illustration of the scene representation prediction application of FIG. 1, according to various embodiments;

FIG. 5 is a more detailed illustration of the single-view encoder of FIG. 4, according to various embodiments;

FIG. 6 is a more detailed illustration of multi-view pooling of FIG. 4, according to various embodiments;

FIG. 7 is a more detailed illustration of rendering module of FIG. 4, according to various embodiments;

FIG. 8 is a more detailed illustration of model trainer of FIG. 1, according to various embodiments;

FIG. 9 is a more detailed illustration of distillation module of FIG. 8, according to various embodiments;

FIG. 10 sets forth a flow diagram of method steps for generating generalized scene representations, according to various embodiments; and

FIG. 11 sets forth a flow diagram of method steps for generating training data from offline NeRFs and foundation models, according to various embodiments.

### DETAILED DESCRIPTION

In the following description, numerous specific details are set forth to provide a more thorough understanding of the various embodiments. However, it will be apparent to one of skilled in the art that the inventive concepts may be practiced without one or more of these specific details.

### System Overview

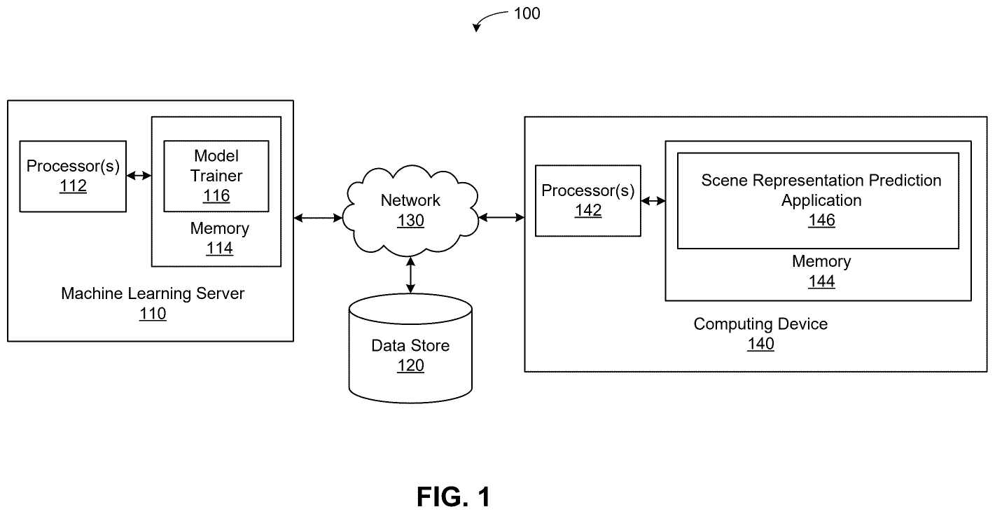

FIG. 1 illustrates a block diagram of a computer-based system 100 configured to implement one or more aspects of the various embodiments. As shown, the system 100 includes, without limitation, a machine learning server 110, a data store 120, and a computing device 140 in communication over a network 130, which can be a wide area network (WAN) such as the internet, a local area network (LAN), a cellular network, and/or any other suitable network.

As also shown, a model trainer 116 executes on one or more processors 112 of the machine learning server 110 and is stored in a system memory 114 of the machine learning server 110. The one or more processors 112 receive user input from input devices, such as a keyboard or a mouse. In operation, the one or more processors 112 may include one or more primary processors of the machine learning server 110, controlling and coordinating operations of other system components. In particular, the processor(s) 112 can issue commands that control the operation of one or more graphics processing units (GPUs) (not shown) and/or other parallel processing circuitry (e.g., parallel processing units, deep learning accelerators, etc.) that incorporates circuitry optimized for graphics and video processing, including, for example, video output circuitry. The GPU(s) can deliver pixels to a display device that can be any conventional cathode ray tube, liquid crystal display, light-emitting diode display, and/or the like.

The system memory 114 of the machine learning server 110 stores content, such as software applications and data, for use by the processor(s) 112 and the GPU(s) and/or other processing units. The system memory 114 can be any type of memory capable of storing data and software applications, such as a random-access memory (RAM), a read-only memory (ROM), an erasable programmable read-only memory (EPROM or flash ROM), or any suitable combination of the foregoing. In some embodiments, a storage (not shown) can supplement or replace the system memory 114. The storage can include any number and type of external memories that are accessible to the processor 112 and/or the GPU. For example, and without limitation, the storage can include a secure digital card, an external flash memory, a portable compact disc read-only memory (CD-ROM), an optical storage device, a magnetic storage device, and/or any suitable combination of the foregoing.

The machine learning server 110 shown herein is for illustrative purposes only, and variations and modifications are possible without departing from the scope of the present disclosure. For example, the number of processors 112, the number of GPUs and/or other processing unit types, the number of system memories 114, and/or the number of applications included in the system memory 114 can be modified as desired. Further, the connection topology between the various units in FIG. 1 can be modified as desired. In some embodiments, any combination of the processor(s) 112, the system memory 114, and/or GPU(s) can be included in and/or replaced with any type of virtual computing system, distributed computing system, and/or cloud computing environment, such as a public, private, or a hybrid cloud system.

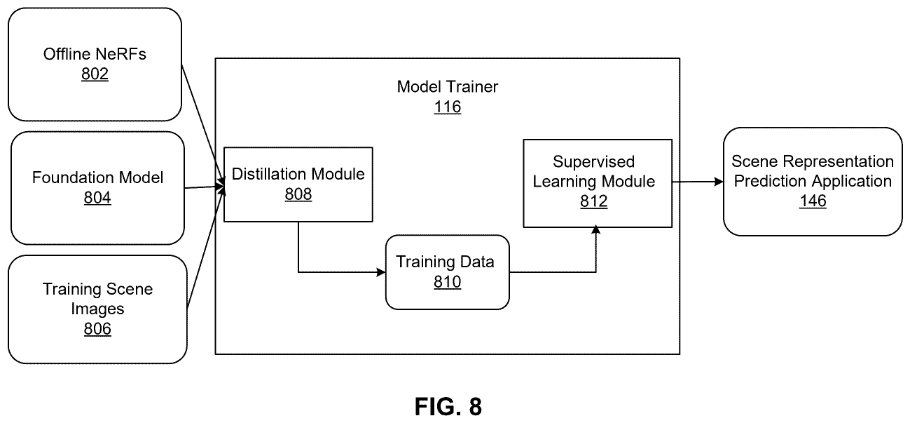

In some embodiments, the model trainer 116 is configured to train one or more machine learning models, including scene representation prediction application 146. Techniques that the model trainer 116 can use to train the machine learning model(s) are discussed in greater detail below in conjunction with FIGS. 8-9 and 11. Training data and/or trained (or deployed) machine learning models, including scene representation prediction application 146, can be stored in the data store 120. In some embodiments, the data store 120 can include any storage device or devices, such as fixed disc drive(s), flash drive(s), optical storage, network attached storage (NAS), and/or a storage area-network (SAN). Although shown as accessible over the network 130, in at least one embodiment, the machine learning server 110 can include the data store 120.

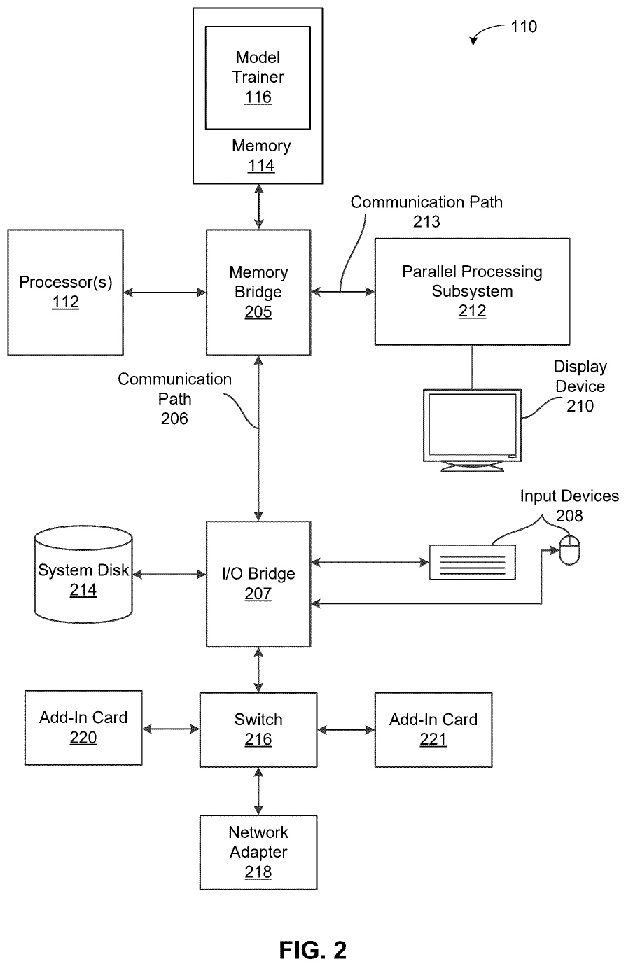

FIG. 2 is a block diagram illustrating the machine learning server 110 of FIG. 1 in greater detail, according to various embodiments. Machine learning server 110 may be any type of computing system, including, without limitation, a server machine, a server platform, a desktop machine, a laptop machine, a hand-held/mobile device, a digital kiosk, or a wearable device. In some embodiments, machine learning server 110 is a server machine operating in a data center or a cloud computing environment that provides scalable computing resources as a service over a network.

In various embodiments, machine learning server 110 includes, without limitation, the processor(s) 112 and the memory (IES) 114 coupled to a parallel processing subsystem 212 via a memory bridge 205 and a communication path 213. Memory bridge 205 is further coupled to an I/O (input/output) bridge 207 via a communication path 206, and I/O bridge 207 is, in turn, coupled to a switch 216.

In one embodiment, I/O bridge 207 is configured to receive user input information from optional input devices 208, such as a keyboard, mouse, touch screen, sensor data analysis (e.g., Evaluating gestures, speech, or other information about one or more uses in a field of view or sensory field of one or more sensors), and/or the like, and forward the input information to the processor(s) 112 for processing. In some embodiments, machine learning server 110 may be a server machine in a cloud computing environment. In such embodiments, machine learning server 110 may not include input devices 208 but may receive equivalent input information by receiving commands (e.g., responsive to one or more inputs from a remote computing device) in the form of messages transmitted over a network and received via the network adapter 218. In some embodiments, switch 216 is configured to provide connections between I/O bridge 207 and other components of the machine learning server 110, such as a network adapter 218 and various add-in cards 220 and 221.

In some embodiments, I/O bridge 207 is coupled to a system disk 214 that may be configured to store content and applications and data for use by processor(s) 112 and parallel processing subsystem 212. In one embodiment, system disk 214 provides non-volatile storage for applications and data and may include fixed or removable hard disk drives, flash memory devices, and CD-ROM (compact disc read-only-memory), DVD-ROM (digital versatile disc-rom), Blu-ray, HD-DVD (high-definition DVD), or other magnetic, optical, or solid state storage devices. In various embodiments, other components, such as universal serial bus or other port connections, compact disc drives, digital versatile disc drives, film recording devices, and the like, may be connected to I/O bridge 207 as well.

In various embodiments, memory bridge 205 may be a northbridge chip, and I/O bridge 207 may be a southbridge chip. In addition, communication paths 206 and 213, as well as other communication paths within machine learning server 110, may be implemented using any technically suitable protocols, including, without limitation, AGP (accelerated graphics port), hypertransport, or any other bus or point-to-point communication protocol known in the art.

In some embodiments, parallel processing subsystem 212 comprises a graphics subsystem that delivers pixels to an optional display device 210 that may be any conventional cathode ray tube, liquid crystal display, light-emitting diode display, and/or the like. In such embodiments, the parallel processing subsystem 212 may incorporate circuitry optimized for graphics and video processing, including, for example, video output circuitry. Such circuitry may be incorporated across one or more parallel processing units (PPUs), also referred to herein as parallel processors, included within the parallel processing subsystem 212. In various embodiments, the parallel processing subsystem 212 incorporates circuitry optimized (e.g., That undergoes optimization) for general purpose and/or compute processing. Again, such circuitry may be incorporated across one or more PPUs included within parallel processing subsystem 212 that are configured to perform such general purpose and/or compute operations. In yet other embodiments, the one or more PPUs included within parallel processing subsystem 212 may be configured to perform graphics processing, general purpose processing, and/or compute processing operations.

In various embodiments, parallel processing subsystem 212 may be integrated with one or more of the other elements of FIG. 2 to form a single system. For example, parallel processing subsystem 212 may be integrated with processor 112 and other connection circuitry on a single chip to form a system on a chip (soc).

System memory 114 includes at least one device driver configured to manage the processing operations of the one or more PPUs within parallel processing subsystem 212. In addition, the system memory 114 includes the model trainer 116. Although described herein primarily with respect to the model trainer 116, techniques disclosed herein can also be implemented, either entirely or in part, in other software and/or hardware, such as in the parallel processing subsystem 212.

In some embodiments, processor(s) 112 includes the primary processor of machine learning server 110, controlling and coordinating operations of other system components. In some embodiments, the processor(s) 112 issues commands that control the operation of PPUs. In some embodiments, communication path 213 is a PCI express link, in which dedicated lanes are allocated to each PPU. Other communication paths may also be used. The PPU advantageously implements a highly parallel processing architecture, and the PPU may be provided with any amount of local parallel processing memory.

It will be appreciated that the system shown herein is illustrative and that variations and modifications are possible. The connection topology, including the number and arrangement of bridges or the number of parallel processing subsystems 212, may be modified as desired. For example, in some embodiments, system memory 114 could be connected to the processor(s) 112 directly rather than through memory bridge 205, and other devices may communicate with system memory 114 via memory bridge 205 and processor 112. In other embodiments, parallel processing subsystem 212 may be connected to I/O bridge 207 or directly to processor 112, rather than to memory bridge 205. In still other embodiments, I/O bridge 207 and memory bridge 205 may be integrated into a single chip instead of existing as one or more discrete devices. In certain embodiments, one or more components shown in FIG. 2 may not be present. For example, switch 216 could be eliminated, and network adapter 218 and add-in cards 220, 221 would connect directly to I/O bridge 207. Lastly, in certain embodiments, one or more components shown in FIG. 2 may be implemented as virtualized resources in a virtual computing environment, such as a cloud computing environment. In particular, the parallel processing subsystem 212 may be implemented as a virtualized parallel processing subsystem in at least one embodiment. For example, the parallel processing subsystem 212 may be implemented as a virtual graphics processing unit(s) (VPU(s)) that renders graphics on a virtual machine(s) (VM(s)) executing on a server machine(s) whose GPU(s) and other physical resources are shared across one or more VMs.

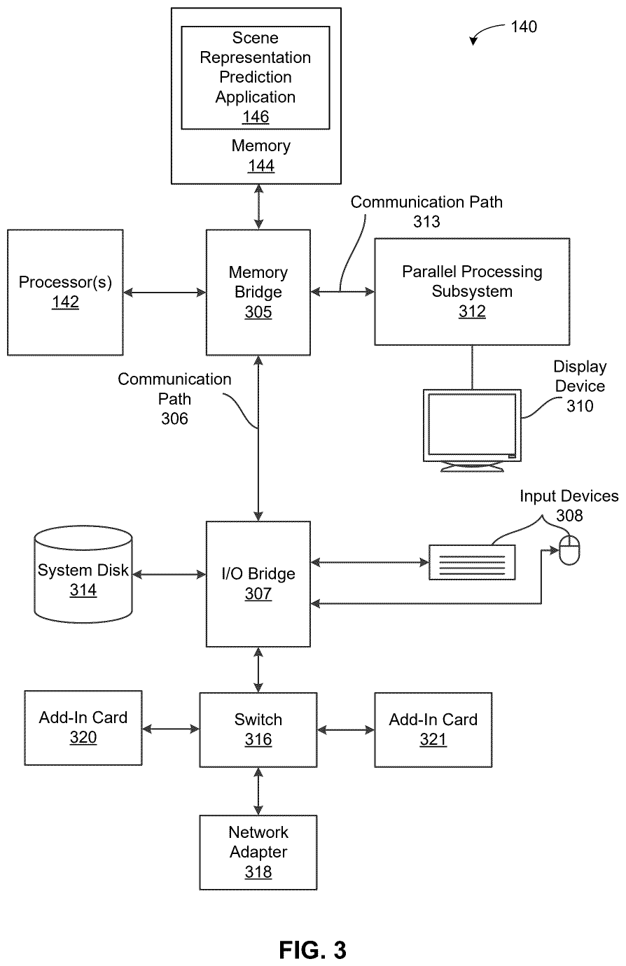

FIG. 3 is a block diagram illustrating the computing device 140 of FIG. 1 in greater detail, according to various embodiments. Computing device 140 may be any type of computing system, including, without limitation, a server machine, a server platform, a desktop machine, a laptop machine, a hand-held/mobile device, a digital kiosk, or a wearable device. In some embodiments, computing device 140 is a server machine operating in a data center or a cloud computing environment that provides scalable computing resources as a service over a network.

In various embodiments, the computing device 140 includes, without limitation, the processor(s) 142 and the memory (IES) 144 coupled to a parallel processing subsystem 312 via a memory bridge 305 and a communication path 313. Memory bridge 305 is further coupled to an I/O (input/output) bridge 307 via a communication path 306, and I/O bridge 307 is, in turn, coupled to a switch 316.

In one embodiment, I/O bridge 307 is configured to receive user input information from optional input devices 308, such as a keyboard, mouse, touch screen, sensor data analysis (e.g., evaluating gestures, speech, or other information about one or more uses in a field of view or sensory field of one or more sensors), and/or the like, and forward the input information to the processor(s) 142 for processing. In some embodiments, the computing device 140 may be a server machine in a cloud computing environment. In such embodiments, computing device 140 may not include input devices 308, but may receive equivalent input information by receiving commands (e.g., Responsive to one or more inputs from a remote computing device) in the form of messages transmitted over a network and received via the network adapter 318. In some embodiments, switch 316 is configured to provide connections between I/O bridge 307 and other components of the scene representation prediction application 146, such as a network adapter 318 and various add-in cards 320 and 321.

In some embodiments, I/O bridge 307 is coupled to a system disk 314 that may be configured to store content and applications and data for use by processor(s) 142 and parallel processing subsystem 312. In one embodiment, system disk 314 provides non-volatile storage for applications and data and may include fixed or removable hard disk drives, flash memory devices, and CD-ROM (compact disc read-only-memory), DVD-ROM (digital versatile disc-rom), Blu-ray, HD-DVD (high-definition DVD), or other magnetic, optical, or solid state storage devices. In various embodiments, other components, such as universal serial bus or other port connections, compact disc drives, digital versatile disc drives, film recording devices, and the like, may be connected to I/O bridge 307 as well.

In various embodiments, memory bridge 305 may be a northbridge chip, and I/O bridge 307 may be a southbridge chip. In addition, communication paths 306 and 313, as well as other communication paths within scene representation prediction application 146, may be implemented using any technically suitable protocols, including, without limitation, AGP (accelerated graphics port), hypertransport, or any other bus or point-to-point communication protocol known in the art.

In some embodiments, parallel processing subsystem 312 comprises a graphics subsystem that delivers pixels to an optional display device 310 that may be any conventional cathode ray tube, liquid crystal display, light-emitting diode display, and/or the like. In such embodiments, the parallel processing subsystem 312 may incorporate circuitry optimized for graphics and video processing, including, for example, video output circuitry. Such circuitry may be incorporated across one or more parallel processing units (PPUs), also referred to herein as parallel processors, included within the parallel processing subsystem 312. In various embodiments, the parallel processing subsystem 312 incorporates circuitry optimized (e.g., That undergoes optimization) for general purpose and/or compute processing. Again, such circuitry may be incorporated across one or more PPUs included within parallel processing subsystem 312 that are configured to perform such general purpose and/or compute operations. In yet other embodiments, the one or more PPUs included within parallel processing subsystem 312 may be configured to perform graphics processing, general purpose processing, and/or compute processing operations.

In various embodiments, parallel processing subsystem 312 may be integrated with one or more of the other elements of FIG. 3 to form a single system. For example, parallel processing subsystem 312 may be integrated with processor 142 and other connection circuitry on a single chip to form a system on a chip (soc).

System memory 144 includes at least one device driver configured to manage the processing operations of the one or more PPUs within parallel processing subsystem 312. In addition, the system memory 144 includes the model trainer 116. Although described herein primarily with respect to the model trainer 116, techniques disclosed herein can also be implemented, either entirely or in part, in other software and/or hardware, such as in the parallel processing subsystem 312.

In some embodiments, processor(s) 142 includes the primary processor of scene representation prediction application 146, controlling and coordinating operations of other system components. In some embodiments, the processor(s) 142 issues commands that control the operation of PPUs. In some embodiments, communication path 313 is a PCI express link, in which dedicated lanes are allocated to each PPU. Other communication paths may also be used. The PPU advantageously implements a highly parallel processing architecture, and the PPU may be provided with any amount of local parallel processing memory (pp memory).

It will be appreciated that the system shown herein is illustrative and that variations and modifications are possible. The connection topology, including the number and arrangement of bridges or the number of parallel processing subsystems 312, may be modified as desired. For example, in some embodiments, system memory 144 could be connected to the processor(s) 142 directly rather than through memory bridge 305, and other devices may communicate with system memory 144 via memory bridge 305 and processor 142. In other embodiments, parallel processing subsystem 312 may be connected to I/O bridge 307 or directly to processor 142, rather than to memory bridge 305. In still other embodiments, I/O bridge 307 and memory bridge 305 may be integrated into a single chip instead of existing as one or more discrete devices. In certain embodiments, one or more components shown in FIG. 3 may not be present. For example, switch 316 could be eliminated, and network adapter 318 and add-in cards 320, 321 would connect directly to I/O bridge 307. Lastly, in certain embodiments, one or more components shown in FIG. 3 may be implemented as virtualized resources in a virtual computing environment, such as a cloud computing environment. In particular, the parallel processing subsystem 312 may be implemented as a virtualized parallel processing subsystem in at least one embodiment. For example, the parallel processing subsystem 312 may be implemented as a virtual graphics processing unit(s) (VPU(s)) that renders graphics on a virtual machine(s) (VM(s)) executing on a server machine(s) whose GPU(s) and other physical resources are shared across one or more VMs.

### Scene Representation Prediction Application

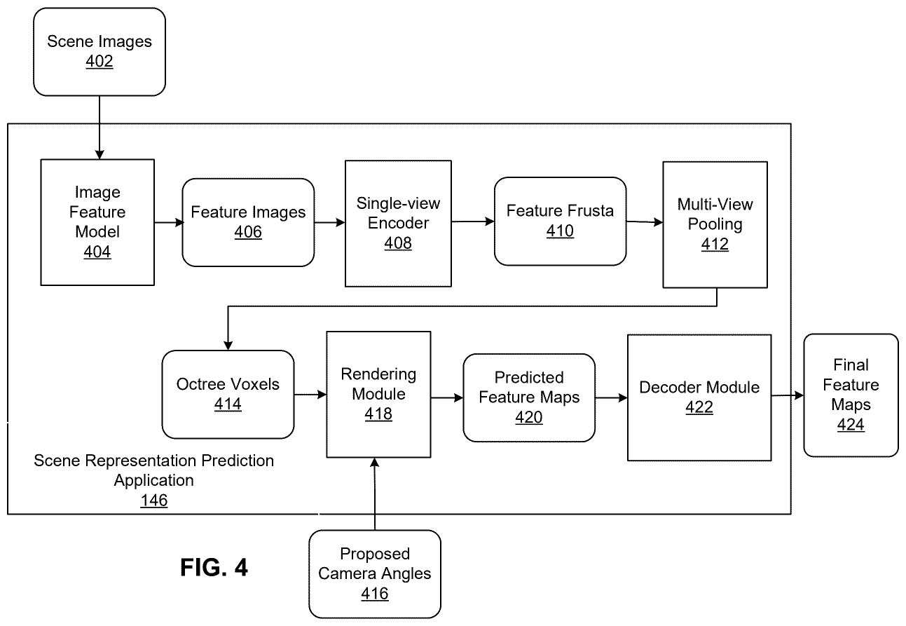

FIG. 4 is a more detailed illustration of the scene representation prediction application 146 of FIG. 1, according to various embodiments. As shown, scene representation prediction application 146 includes an image feature model 404, a single-view encoder 408, a multi-view pooling module 412, a rendering module 418, and a decoder module 422 that operate sequentially to produce final feature images 424 based on scene images 402 and proposed camera angles 416.

Scene images 402 are a collection of RGB (red-green-blue) images captured from various angles of a given scene. In some embodiments, scene images 402 may be images taken from multiple cameras on the exterior of a vehicle in order to capture the environment and objects surrounding the vehicle. In operation, image feature model 404 accepts scene images 402 as input and produces feature images 406 as output. In some embodiments, image feature model 404 is a pre-trained image model that transforms each scene image 402 into a new feature image 406 by encoding higher-level feature information from the scene image 402 into the feature image 406. For example, image feature model 404 may be constructed from a large-scale foundation model and may encode classification information about the types of objects in the given scene. In other embodiments, no additional features are used to extend scene images 402. In such cases, image feature model 404 serves as a passthrough, and feature images 406 are substantially similar to scene images 402 and include no additional features.

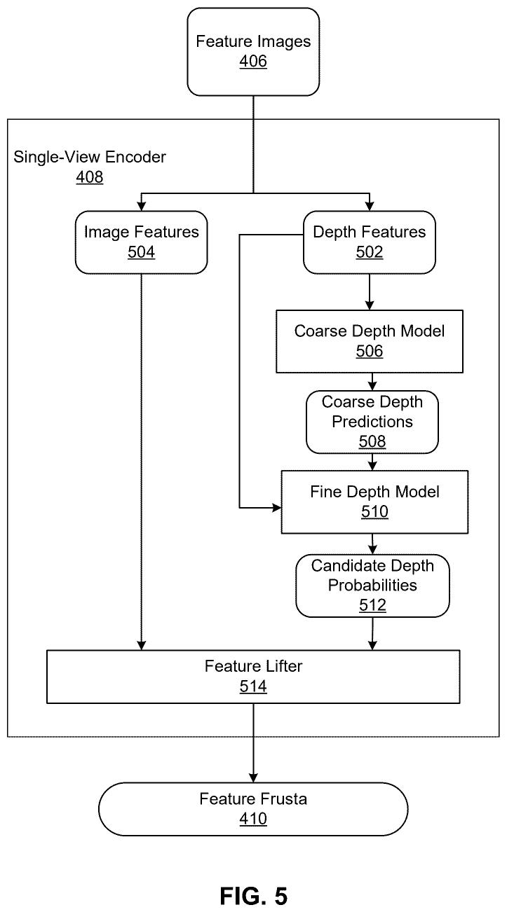

Single-view encoder 408 accepts feature images 406 as input and produces feature frusta 410 as output. As described in greater detail below in conjunction with FIG. 5, to generate feature frusta 410, single-view encoder 408 estimates the depth of each pixel included in each given feature image 406. Single-view encoder 408 then embeds each given feature image 406 into a 3D frustrum by extending each pixel of a feature image 406 with the depth estimate. Each of the resulting feature frusta 410 expands a given feature image 406 from a 2D image into a 3D structure that estimates the depth of the image features included in the respective feature image 406 as well as the 2D positions of those image features.

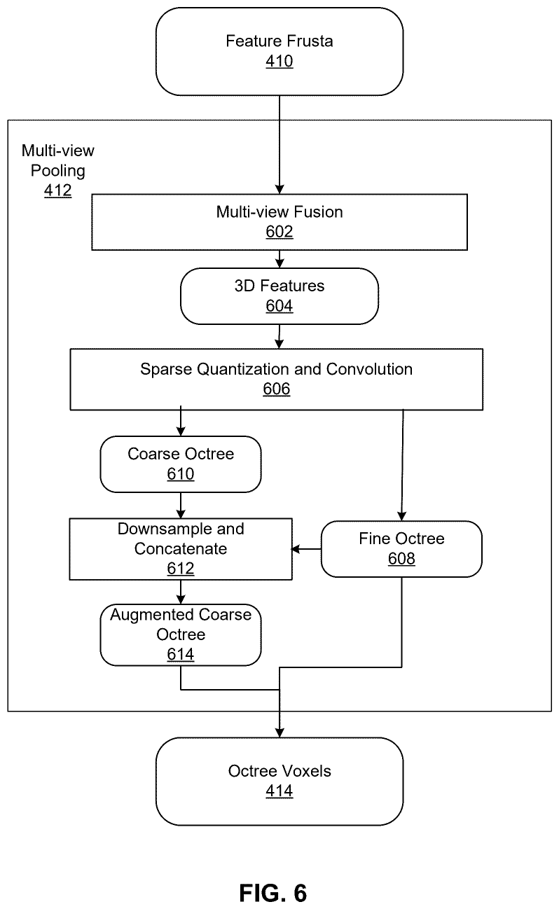

Multi-view pooling module 412 combines feature frusta 410 into a unified set of octree voxels 414. As described in greater detail below in conjunction with FIG. 6, multi-view pooling module 412 combines all feature frusta 410 into a single, unified 3D feature volume. Multi-view pooling module 412 then applies a series of sparse quantization and convolutions to encode the 3D feature volume into octree voxels 414. Octree voxels 414 include a pair of octrees of differing resolutions. The “coarse” octree encodes high-level feature information from the 3D feature volume, and the “fine” octree encodes addition low-level feature information from the 3D feature volume. Together, these octrees comprise octree voxels 414, which efficiently encode a 3D representation of the scene originally captured in scene images 402.

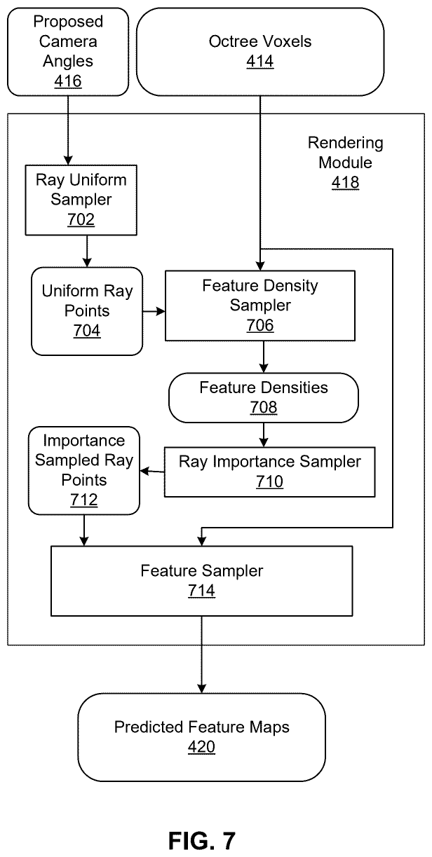

Rendering module 418 accepts octree voxels 414 and proposed camera angles 416 as input and produces predicted feature images 420 as output. As described in greater detail below in conjunction with FIG. 7, rendering module 418 generates a predicted feature image 420 for each camera angle proposed in proposed camera angles 416 by sampling from octree voxels 414. Rendering module 418 projects rays from each virtual pixel in proposed camera angle 416 through both octrees in octree voxels 414. For each projected ray, all intersected octree cells are aggregated into a single predicted feature pixel. All predicted feature pixels are subsequently combined into a predicted feature image 420. This process is repeated for every proposed camera angle 416 until all predicted feature images 420 are generated.

Decoder module 422 accepts predicted feature images 420 as input and produces final feature images 424 as output. Decoder module 422 is a neural network module that applies supplemental transformations to predicted feature images 420, depending on the final application, to generate final feature images 424. For example, in some embodiments, decoder module 422 may enhance high-frequency details or upsample the images included in predicted feature images 420 to a higher resolution in order to create predicted feature images 424 that are more suitable for human viewing. In other embodiments, decoder module 422 may apply object classification and bounding boxes to specific types of objects included in predicted feature images 420 in order to aid in tracking obstacles in the scene originally captured in scene images 402.

FIG. 5 is a more detailed illustration of the single-view encoder 408 of FIG. 4, according to various embodiments. As shown, single-view encoder 408 includes depth features 502, images features 504, coarse depth model 506, coarse depth predictions 508, fine depth model 510, candidate depth probabilities 512, and feature lifter 514 that operate as described below to produce feature frusta 410 from feature images 406.

Upon being input into single-view encoder 408, feature images 406 is separated into depth features 502 and image features 504. Depth features 502 is the subset of features in feature images 406 that are useful for depth prediction. Image features 504 are the remaining features in feature images 406 not present in depth features 502. For example, in some embodiments, depth features 502 may include the original RGB images from scene images 402, and image features 504 may include all additional features created by image feature model 404.

Coarse depth model 506 accepts depth features 502 as input and produces coarse depth predictions 508 as output. In operation, coarse depth model 506 passes depth features 502 to a 2D backbone model (not shown) that assigns each pixel associated with depth features 502 a probability distribution of possible depth values. The possible depth values are represented as depth probability density values in a set of coarse, pre-defined depth ranges. Given this 3D coarse depth map, the coarse occupancy weight of each 3D pixel can be computed via the following formula:

$$O ( h , w , d ) = exp ( - {\sum }_{j = 1}^{d - 1} {δ}_{j} {σ}_{h , w , j} ) ( 1 - exp ( - {δ}_{d} {σ}_{h , w , d} ) ) \qquad ( 1 )$$

where h, w, d represent the height, width, and depth pixels of the 3D depth map, respectively, σ_{h,w,d} is the depth probability density for pixel (h,w,d), and δ_{d} is the width of depth range d. Given the occupancy weight for each 3D pixel, the 2D coarse depth prediction 508 for each 2D pixel can be produced via ray marching:

$$D ( h , w ) = {\sum }_{d = 1}^{D} O ( h , w , d ) {t}_{d} \qquad ( 2 )$$

where t_{d} is the depth of depth range d.

Fine depth model 510 accepts depth features 502 and coarse depth predictions 508 as input and produces candidate depth probabilities 512 as output. For each coarse depth prediction 508 received, fine depth model 510 generates a set of depth candidate buckets centered around that coarse depth prediction 508. A second 2D backbone model (not shown) then generates fine depth density values from depth features 502 for each of the depth candidate buckets included in the set of depth candidate buckets. The fine depth density values are subsequently converted into fine occupancy weights via the same process implemented by coarse depth model 506 in computing the coarse occupancy weights, described above. In fine depth model 510, the fine occupancy weights are interpreted as probabilities and returned as candidate depth probabilities 512.

Feature lifter 514 accepts image features 504 and candidate depth probabilities 512 as input and produces feature frusta 410 as output. Feature lifter 514 maps each image feature 504 onto the candidate depth probabilities 512, producing a different feature frustum 410 for each image feature 504. In some embodiments, a feature pyramid network or similar model architecture can be used to lift each of the 2D image features 504 into a feature frustum 410.

FIG. 6 is a more detailed illustration of multi-view pooling 412 of FIG. 4, according to various embodiments. As shown, multi-view pooling 412 includes multi-view fusion 602, 3D features 604, sparse quantization and convolution 606, fine octree 608, downsample and concatenate 610, and coarse octree 612 that operate as described below to produce octree voxels 414 from feature frusta 410.

In this regard, multi-view fusion 602 first accepts feature frusta 410 generated by single view encoder 408 as input and produces 3D features 610 as output. More specifically, multi-view fusion 602 combines all feature frusta 410 into a single unified 3D feature volume. Each feature frustum 410 is rotated to the same orientation of the corresponding scene images 402 relative to the 3D feature volume. The features within each feature frustum 410 are placed at the appropriate corresponding angle and depth within the 3D feature volume. When two sets of features are in the same 3D voxel, they are combined using average pooling. Additionally, the 3D coordinates of the voxels are transformed such that the exterior voxels have unbounded upper size. The unbounded upper size of exterior voxels advantageously enables better representation of outdoor scenes and other large scene volumes. Voxel coordinates can be transformed via the following formulae:

$$f ( p ) = α ( p / {p}_{inner} ) if \vert p \vert \leq {P}_{inner} \qquad ( 3 )$$

$$f ( p ) = p / \vert p \vert ( 1 - ( {p}_{inner} / \vert p \vert ) ( 1 - α ) ) if \vert p \vert > {P}_{inner} \qquad ( 4 )$$

where α and pᵢₙₙₑᵣ denote the proportion and size of the interior region, respectively, and p=(x,y,z).

Sparse quantization and convolution 606 accepts 3D features 604 as input and produces two different octrees as output, fine octree 608 and a coarse octree 610. Sparse quantization and convolution 606 applies a sparse quantization procedure to convert 3D features 604 into sparse recursive octree representations. Specifically, 3D features 604 are recursively divided into multiple levels of quantization, where lower levels of quantization contain summary information about higher resolution cells below. This sparse quantization approach efficiently represents large empty regions while capturing feature dense regions with high accuracy. Sparse quantization and convolution 606 applies this procedure to both a coarse and fine final resolution, producing fine octree 608 and coarse octree 610. Sparse quantization and convolution 606 then applies sparse convolutions to both octrees, encoding interactions and relationships between nearby cells. At the conclusion of the quantization and convolution operations, fine octree 608 and coarse octree 610 are then passed to downsample and concatenate 612. Downsample and concatenate 612 downsamples the features of fine octree 608 and appends the down-sampled features to the features of the coarse octree 610 to produce augmented coarse octree 612. Fine octree 608 and coarse octree 612 are combined to form octree voxel 414.

FIG. 7 is a more detailed illustration of rendering module 418 of FIG. 4, according to various embodiments. As shown, rendering module 418 includes ray uniform sampler 702, uniform ray points 704, feature density sampler 706, feature densities 708, ray importance sampler 710, importance sampled ray points 712, and feature sampler 714 that operate sequentially to produce predicted feature maps 420 from octree voxels 414 and proposed camera angles 416.

Ray uniform sampler 702 accepts proposed camera angles 416 as input and produces uniform ray points 704 as output. In this regard, given proposed camera angles 416, ray uniform sampler 702 orients one or more virtual cameras at the appropriate distances and orientations relative to the scene represented by octree voxels 414. Ray uniform sampler 702 then projects a virtual ray from the position and angle of each virtual pixel of each virtual camera and proposes a set of uniformly spaced points along each ray. These proposed points are returned as uniform ray points 704.

Feature density sampler 706 accepts uniform ray points 704 and octree voxels 414 as input and produces feature densities 708 as output. In this regard, feature density sampler 706 queries octree voxels 414 at each of the points included in uniform ray points 704. Specifically, all octrees contained within octree voxels 414 are queried by feature density sampler 706. The number of times each uniform ray point 704 is located in a non-empty voxel cell in each octree is recorded as a feature density measurement. These feature density measurements are returned as feature densities 708.

Ray importance sampler 710 accepts feature densities 708 as input and produces importance sampled ray points 712 as output. In this regard, ray importance sampler 710 performs a similar procedure as ray uniform sampler 702, where ray importance sampler 710 samples points along a virtual ray projected from the position and angle of each virtual pixel of each virtual camera angle 416. Instead of uniform sampling, ray importance sampler 710 performs an importance sampling procedure based on feature densities 708. The importance sampling procedure preferentially samples points at higher feature densities 708, so important features along the virtual ray will be sufficiently sampled. These importance sampled ray points are returned as importance sampled ray points 712.

Feature sampler 714 accepts octree voxels 414 and importance sampled ray points 712 as input and produces predicted feature maps 420 as output. In this regard, feature sampler 714 samples octree voxels 414 at importance sampled ray points 712. The features sampled from each octrees are concatenated together to form the final features. The final features and densities are aggregated using ray marching, as described above in Equation 2, to produce predicted feature maps 420.

### Training Scene Representation Prediction Application

FIG. 8 is a more detailed illustration of model trainer 116 of FIG. 1, according to various embodiments. As shown, model trainer 116 accepts offline NeRFs 802, foundation model 804, and training scene images 806 as inputs and returns scene representation prediction application 146 as output. Offline NeRFs 802 are a collection of pre-trained NeRF models, capable of producing depth and image predictions from proposed camera angles of a given scene. Foundation model 804 is a large scale model capable of applying high-level label features to a given image. For example, in some embodiments, foundation model 804 may perform object detection and labeling of pixels in an image depending on what objects are captured by those pixels. Training scene images 806 are a collection of images representing various scenes used to train offline NeRFs 802.

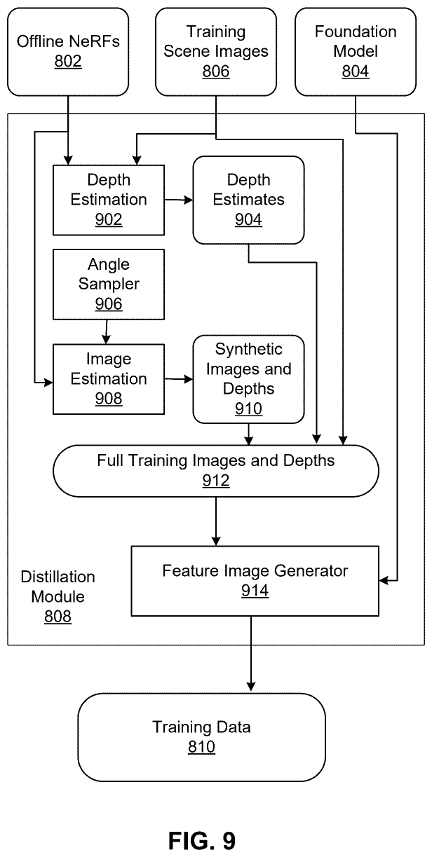

Distillation module 808 leverages offline NeRFs 802 and foundation model 804 to extend the information present in training images 806. Distillation module 808 uses offline NeRFs 802 to produce depth estimates for training images 806 and also produces additional synthetic training images and depths. Additionally, distillation module 808 uses foundation model 804 to generate rich feature images from training images 806 and synthetic images to create the training data 810. The operations of distillation module 808 are described in further detail below in conjunction with FIG. 9.

Supervised learning module 812 accepts training data 810 output from distillation module 808 and produces scene representation and prediction application 146 that can be used for a variety of inferencing operations, such as autonomous vehicle control or high resolution object detection and modeling. In operation, supervised learning module 812 minimizes the loss on prediction across multiple stages of the scene representation and prediction application 146. The loss is computed from the difference of both the image and depth predictions of the original RGB images compared to their training counterparts. An additional loss term is computed on the predictions of the features produced by foundation model 804 compared to their training counterparts. These different losses are summed and minimized over multiple training epochs until convergence is reached, thereby producing the final, trained version of scene representation and prediction application 146.

FIG. 9 is a more detailed illustration of distillation module 808 of FIG. 8, according to various embodiments. Distillation module 808 accepts offline NeRFs 802, training scene images 806, and foundation model 804 as input and produces training data 916 as output. In so doing, distillation module 808 uses offline NeRFs 802 and foundation model 804 to synthetically expand and augment the data in training scene images 806. First, depth estimation 902 produces depth estimates 904 for each image in training scene images 806 using offline NeRFs 802. Offline NeRFs 802 produces dense depth estimates for all pixels of each image in training scene images 806. In other embodiments, depth estimation 902 may produce depth estimates 904 without explicitly referencing training scene images 806, instead sampling the depth estimates directly from offline NeRFs 802. Next, angle sampler 906 proposes several new virtual camera angles from which to sample synthetic images. Image estimation 908 accepts these sampled angles and offline NeRFs 802 as input and produces synthetic images and depths 802 as output. Offline NeRFs 802 produces a synthetic image and depth estimate of the scene as viewed from the provided virtual camera angle. Training scene images 806, depth estimates 904, and synthetic images and depths 910 are all combined as full training images and depths 912, creating one unified training dataset of original and synthetic images and depths. In other embodiments, only synthetic images and depths are used, and training scene images 806 and depth estimates 904 do not have to be generated. Finally, feature image generator 914 accepts full training images and depths 912 and foundation model 804 and generates a feature image for each training image and depth 912. Foundation model 804 analyzes training image and depth 912 and identifies and encodes high level structural information about the contents into a feature image. The feature image produced contains additional feature information about the image. For example, in some embodiments, the feature image may contain encoded information about the types of objects in the scene as determined by foundation model 804. These rich feature images are returned as training data 810.

### Inferencing and Training Operations

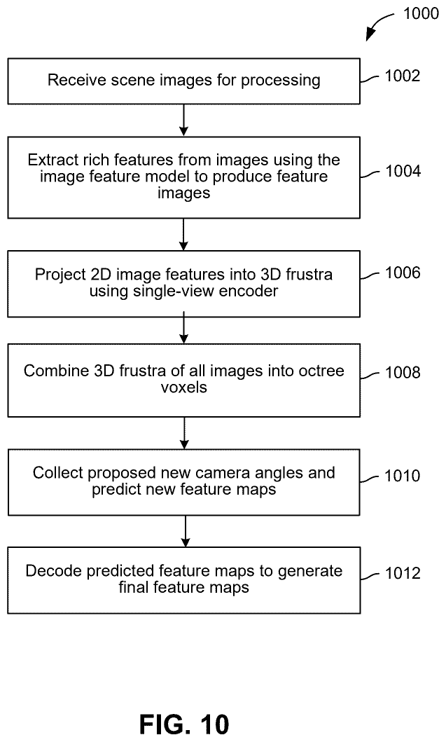

FIG. 10 sets forth a flow diagram of method steps for generating generalized scene representations, according to various embodiments. Although the method steps are described in conjunction with the systems of FIGS. 1-9, persons skilled in the art will understand that any system configured to perform the method steps in any order falls within the scope of the present disclosure.

As shown, method 1000 begins at step 1002, where scene representation prediction application 146 receives scene images 402 for processing to generate final feature maps 424. Scene images 402 may be a collection of images showing various angles of a given scene. For example, in some embodiments scene images 402 may be a set of images captured by cameras on the exterior of a car driving on a road.

At step 1004, image feature model 404 extracts rich features from scene images 402 to produce feature images 406. In some embodiments, image feature model 404 is a foundation model that infers high-level object information of the given scene and encodes that information as one or more feature images 406. In other embodiments, image feature model 404 may be a simple passthrough, and no additional feature information beyond that contained in scene images 402 is passed on as feature images 406.

At step 1006, single-view encoder 408 projects feature images 406 to produce feature frusta 410. Single-view encoder 408 estimates the depth of each pixel in each feature image 406. Each feature in each pixel of feature image 406 is projected into a 3D frustrum, placing the 2D feature in 3D space using the depth estimate. A 3D frustrum is produced for each feature image 406 to generate feature frusta 410.

At step 1008, multi-view pooling 412 combines feature frusta 410 to produce octree voxels 414. Multi-view pooling 412 orients all feature frusta 410 relative to their appropriate location and combines the features in each feature frustum 410 into a single feature volume. Multi-view pooling 412 then performs a series of sparse quantization and convolution operations to represent the feature volume as a series of octrees of differing resolutions comprising octree voxels 414.

At step 1010, octree voxels 414 are passed along with proposed camera angles 416 to rendering module 418 to produce predicted feature maps 420. Rendering module 418 samples points along the view of proposed camera angles 416 relative to octree voxels 414 to produce a set of feature angles and depths. These feature samples are aggregated into predicted feature map 420 via a ray marching procedure. This procedure is repeated for all proposed camera angles 416, producing a predicted feature map 420 for each proposed camera angle.

At step 1012, decoder module 422 accepts predicted feature maps 420 as input and produces final feature maps 424 as output. Decoder module 422 is a neural network module that applies supplemental transformations to predicted feature images 420, depending on the final application of scene representation and prediction application 146, to generate final feature images 424. For example, in some embodiments, decoder module 422 may enhance high-frequency details or increase the resolution of predicted feature maps 420. In other embodiments, decoder module 422 may perform object detection or classification on predicted feature maps 420. Decoder module 422 applies the same transformation to all predicted feature maps 420 to produce final feature maps 424.

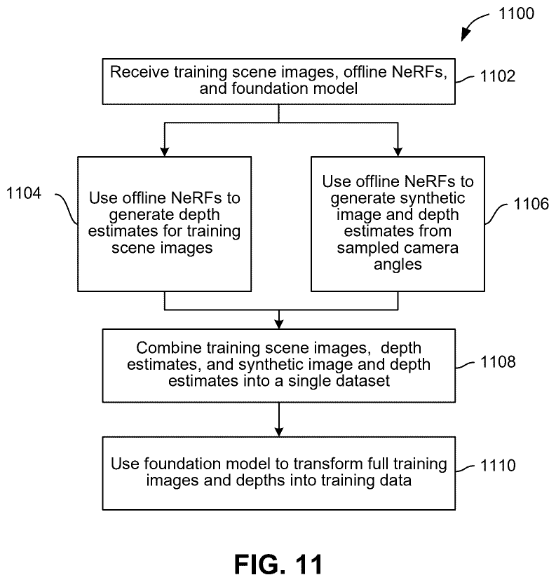

FIG. 11 sets forth a flow diagram of method steps for generating training data from offline NeRFs and foundation models, according to various embodiments. Although the method steps are described in conjunction with the systems of FIGS. 1-9, persons skilled in the art will understand that any system configured to perform the method steps in any order falls within the scope of the present disclosure.

As shown, method 1100 begins at step 1102, where offline NeRFs 802, foundation model 804, and training scene images 806 are received by distillation module 808. Offline NeRFs 802 is a set of a pre-trained NeRF models that are trained on training scene images 806. Foundation model 804 is a foundation-scale artificial intelligence model capable of generating complex features describing the contents of images.

At step 1104, depth estimation 902 produces depth estimates 904 using training scene images 806 and offline NeRFs 802. Offline NeRFs 802 are used to produce dense depth estimates for each image in training scene images 806. In other embodiments, depth estimation 902 may produce depth estimates 904 without explicitly referencing training scene images 806, instead sampling the depth estimates directly from offline NeRFs 802. These estimates are returned as depth estimates 904.

At step 1106, image estimation 908 produces synthetic images and depths 910 using offline NeRFs 802 and sampled angles from angle sampler 906. Step 1106 may be performed in parallel, partially in parallel, or sequentially with step 1104 in various embodiments. Image estimation 908 extends the real training data in training scene images 806 by producing synthetic images and depths by sampling NeRFs 802 at various angles proposed by angle sampler 906. These synthetic images are returned as synthetic images and depths 910.

At step 1108, synthetic images and depths 910 are combined with depth estimates 904 and training scene images 806 to form full training images and depth 912. These images and depths form one full image and depth training dataset. In other embodiments, only synthetic images and depths are used, and training scene images 806 and depth estimates 904 do not have to be generated.

At step 1110, feature image generator 914 accepts full training images and depths 912 and foundation model 804 as input and produces training data 916 as output. Feature image generator 914 uses foundation model 804 to supplement the image and depth data in full training images and depths 912 with rich high-level feature information. For example, in some embodiments, foundation model 804 may produce embeddings containing information about the size and types of objects in the image. These feature images, along with the input full training images and depths 912, are returned as training data 916.

In sum, the disclosed techniques are directed towards predicting generalized scene representations by distilling neural radiance fields into sparse octree voxel models. More specially, in various embodiments, a collection of camera images are collected for a scene from various angles. These images are then mapped to a higher-dimensional feature space, where each pixel of each image includes embedded content information in addition to color values. Each of the resulting feature images is lifted into a 3D frustum using a depth estimation model trained on features distilled from pre-trained Neural Radiance Field (NeRF) models. All 3D frusta are subsequently fused into one set of multi-view voxels, where the voxels are represented by a set of sparse octrees with differing levels of feature resolution. By using multiple octrees of differing resolutions, queries for high-level scene structure can be made quickly and efficiently using the lower-resolution voxels, and, if needed, the higher-resolution voxels can be used to provide supplemental scene details. Lastly, during inference, a set of camera angles are designated by the user for rendering. For each designated camera angle, a simulated camera views the scene from that angle by projecting rays from simulated pixel locations through the multi-view voxels. The features within the voxels intersected by the projected rays are aggregated into simulated pixels. All simulated pixels for each designated camera angle combine to generate a final 2D representation of the scene. In some embodiments, further post-processing is applied to the 2D representation, such as upscaling by a decoder network or object detection and classification.

At least one technical advantage of the disclosed techniques relative to the prior art is that the disclosed techniques achieve high levels of general scene reconstruction accuracy while maintaining computational efficiency. Accordingly, the disclosed techniques enable 3D reconstruction of scenes to be implemented in real-time or near real-time in autonomous vehicle control settings. Another technical advantage of the disclosed techniques is the more efficient utilization of 2D training data via distillation from pre-trained NeRF models. As a result, with the disclosed techniques, substantially less training data is needed to achieve required levels of accuracy for 3D reconstruction of scenes. These technical advantages provide one or more technological advances over prior art approaches.
1. In some embodiments, a computer-implemented method for generating generalized scene representations comprises: extracting feature information from a plurality of scene images; encoding the feature information to generate a plurality of feature images; estimating depths of at least a plurality of pixels in each feature image included in the plurality of feature images to produce a plurality of feature frustra; generating a plurality of octree voxels from the plurality of feature frusta; sampling points along a plurality of views from different proposed camera angles relative to the plurality of octree voxels to produce feature angles and depths that are subsequently aggregated into a plurality of predicted feature maps; and decoding the plurality of predicted feature maps to generate a plurality of final features maps.
2. The computer-implemented method of clause 1, wherein the plurality of scene images comprises a set of images captured by one or more vehicle cameras.
3. The computer-implemented method of clauses 1 or 2, wherein the feature information comprises object information inferred from a scene by a foundation model.
4. The computer-implemented method of any of clauses 1-3, wherein the foundation model encodes the object information to generate the plurality of feature images.
5. The computer-implemented method of any of clauses 1-4, wherein generating the plurality of octree voxels comprises combining one of more features included in each feature frustrum into a feature volume, and performing at least one of one or more quantization or one or more convolution operations on the feature value to produce a series of octrees.
6. The computer-implemented method of any of clause 1-5, wherein the octrees included in the series of octrees have differing resolutions.
7. The computer-implemented method of any of clauses 1-6, wherein the feature angles and depths are subsequently aggregated into the plurality of predicted feature maps via a ray marching procedure applied to a plurality of importance-sampled points.
8. The computer-implemented method of any of clauses 1-7, wherein a different predicted feature map is produced for each proposed camera angle.
9. The computer-implemented method of any of clauses 1-8, wherein decoding the plurality of predicted feature maps comprises applying one or more supplemental transformations to the plurality of predicted feature maps to generate the plurality of final feature maps.
10. The computer-implemented method of any of clauses 1-9, wherein the one or more supplemental transformations include a first transformation, and wherein the first transformation is applied to every predicted feature map included in the plurality of predicted feature maps.
11. In some embodiments, one or more non-transitory, computer-readable media store instructions that, when executed by one or more processors, cause the one or more processors to perform the steps of: extracting feature information from a plurality of scene images; encoding the feature information to generate a plurality of feature images; estimating depths of at least a plurality of pixels in each feature image included in the plurality of feature images to produce a plurality of feature frustra; generating a plurality of octree voxels from the plurality of feature frusta; sampling points along a plurality of views from different proposed camera angles relative to the plurality of octree voxels to produce feature angles and depths that are subsequently aggregated into a plurality of predicted feature maps; and decoding the plurality of predicted feature maps to generate a plurality of final features maps.
12. The one or more non-transitory, computer-readable media of clause 11, where the plurality of scene images comprises a set of images captured by one or more vehicle cameras.
13. The one or more non-transitory, computer-readable media of clauses 11 or 12, wherein the feature information comprises object information inferred from a scene by a foundation model.
14. The one or more non-transitory, computer-readable media of any of clauses 11-13, wherein decoding the plurality of predicted feature maps comprises enhancing high-frequency details included in at least one predicted feature map or increasing a resolution associated with at least one predicted feature map.
15. The one or more non-transitory, computer-readable media of any of clauses 11-14, wherein a decoder module performs at least one of object detection or classification on the plurality of predicted feature maps.
16. The one or more non-transitory, computer-readable media of any of clauses 11-15, wherein the steps of extracting feature information, encoding the feature information, estimating the depths of at least a plurality of pixels, generating the plurality of octree voxels, sampling points along the plurality of views, and decoding the plurality of predicted feature maps are performed by a scene representation prediction application, and wherein the scene representation prediction application is trained using training data generated using a plurality of neural radiance fields.
17. The one or more non-transitory, computer-readable media of any of clauses 11-16, wherein the plurality of neural radiance fields are used to generate depth estimates for training scene images, the training scene images and the depth estimates are combined with synthetic images and depth estimates into a full set of training images and depths, and wherein a foundation model transforms the full set of training images and depths into the training data.
18. The one or more non-transitory, computer-readable media of any of clauses 11-17, wherein the feature angles and depths are subsequently aggregated into the plurality of predicted feature maps via a ray marching procedure applied to a plurality of importance-sampled points.
19. The one or more non-transitory, computer-readable media of any of clauses 11-18, wherein decoding the plurality of predicted feature maps comprises applying one or more supplemental transformations to the plurality of predicted feature maps to generate the plurality of final feature maps.
20. In some embodiments, a computer system comprises: one or more memories storing instructions; and one or more processors that are coupled to the one or more memories and, when executing the instructions, are configured to perform the steps of: extracting feature information from a plurality of scene images, encoding the feature information to generate a plurality of feature images, estimating depths of at least a plurality of pixels in each feature image included in the plurality of feature images to produce a plurality of feature frustra, generating a plurality of octree voxels from the plurality of feature frusta, sampling points along a plurality of views from different proposed camera angles relative to the plurality of octree voxels to produce feature angles and depths, aggregating the feature angles and depths to produce a plurality of predicted feature maps, and decoding the plurality of predicted feature maps to generate a plurality of final features maps.

Any and all combinations of any of the claim elements recited in any of the claims and/or any elements described in this application, in any fashion, fall within the contemplated scope of the present invention and protection.

The descriptions of the various embodiments have been presented for purposes of illustration, but are not intended to be exhaustive or limited to the embodiments disclosed. Many modifications and variations will be apparent to those of ordinary skill in the art without departing from the scope and spirit of the described embodiments.

Aspects of the present embodiments may be embodied as a system, method or computer program product. Accordingly, aspects of the present disclosure may take the form of an entirely hardware embodiment, an entirely software embodiment (including firmware, resident software, micro-code, etc.) or an embodiment combining software and hardware aspects that may all generally be referred to herein as a “module,” a “system,” or a “computer.” In addition, any hardware and/or software technique, process, function, component, engine, module, or system described in the present disclosure may be implemented as a circuit or set of circuits. Furthermore, aspects of the present disclosure may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

Aspects of the present disclosure are described above with reference to flowchart illustrations and/or block diagrams of methods, apparatus (systems) and computer program products according to embodiments of the disclosure. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine. The instructions, when executed via the processor of the computer or other programmable data processing apparatus, enable the implementation of the functions/acts specified in the flowchart and/or block diagram block or blocks. Such processors may be, without limitation, general purpose processors, special-purpose processors, application-specific processors, or field-programmable gate arrays.

The flowchart and block diagrams in the figures illustrate the architecture, functionality, and operation of possible implementations of systems, methods and computer program products according to various embodiments of the present disclosure. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

While the preceding is directed to embodiments of the present disclosure, other and further embodiments of the disclosure may be devised without departing from the basic scope thereof, and the scope thereof is determined by the claims that follow.

What is claimed is:

1. A computer-implemented method for generating generalized scene representations, the method comprising:
extracting feature information from a plurality of scene images;
encoding the feature information to generate a plurality of feature images;
estimating depths of at least a plurality of pixels in each feature image included in the plurality of feature images to produce a plurality of feature frustra;
generating a plurality of octree voxels from the plurality of feature frusta;
sampling points along a plurality of views from different proposed camera angles relative to the plurality of octree voxels to produce feature angles and depths that are subsequently aggregated into a plurality of predicted feature maps; and
decoding the plurality of predicted feature maps to generate a plurality of final features maps.

2. The computer-implemented method of claim 1, wherein the plurality of scene images comprises a set of images captured by one or more vehicle cameras.

3. The computer-implemented method of claim 1, wherein the feature information comprises object information inferred from a scene by a foundation model.

4. The computer-implemented method of claim 3, wherein the foundation model encodes the object information to generate the plurality of feature images.

5. The computer-implemented method of claim 1, wherein generating the plurality of octree voxels comprises combining one of more features included in each feature frustrum into a feature volume, and performing at least one of one or more quantization or one or more convolution operations on the feature value to produce a series of octrees.

6. The computer-implemented method of claim 5, wherein the octrees included in the series of octrees have differing resolutions.

7. The computer-implemented method of claim 1, wherein the feature angles and depths are subsequently aggregated into the plurality of predicted feature maps via a ray marching procedure applied to a plurality of importance-sampled points.

8. The computer-implemented method of claim 1, wherein a different predicted feature map is produced for each proposed camera angle.

9. The computer-implemented method of claim 1, wherein decoding the plurality of predicted feature maps comprises applying one or more supplemental transformations to the plurality of predicted feature maps to generate the plurality of final feature maps.

10. The computer-implemented method of claim 9, wherein the one or more supplemental transformations include a first transformation, and wherein the first transformation is applied to every predicted feature map included in the plurality of predicted feature maps.

11. One or more non-transitory, computer-readable media storing instructions that, when executed by one or more processors, cause the one or more processors to perform the steps of:
extracting feature information from a plurality of scene images;
encoding the feature information to generate a plurality of feature images;
estimating depths of at least a plurality of pixels in each feature image included in the plurality of feature images to produce a plurality of feature frustra;
generating a plurality of octree voxels from the plurality of feature frusta;
sampling points along a plurality of views from different proposed camera angles relative to the plurality of octree voxels to produce feature angles and depths that are subsequently aggregated into a plurality of predicted feature maps; and
decoding the plurality of predicted feature maps to generate a plurality of final features maps.

12. The one or more non-transitory, computer-readable media of claim 11, wherein the plurality of scene images comprises a set of images captured by one or more vehicle cameras.

13. The one or more non-transitory, computer-readable media of claim 11, wherein the feature information comprises object information inferred from a scene by a foundation model.

14. The one or more non-transitory, computer-readable media of claim 11, wherein decoding the plurality of predicted feature maps comprises enhancing high-frequency details included in at least one predicted feature map or increasing a resolution associated with at least one predicted feature map.

15. The one or more non-transitory, computer-readable media of claim 11, wherein a decoder module performs at least one of object detection or classification on the plurality of predicted feature maps.

16. The one or more non-transitory, computer-readable media of claim 11, wherein the steps of extracting feature information, encoding the feature information, estimating the depths of at least a plurality of pixels, generating the plurality of octree voxels, sampling points along the plurality of views, and decoding the plurality of predicted feature maps are performed by a scene representation prediction application, and wherein the scene representation prediction application is trained using training data generated using a plurality of neural radiance fields.

17. The one or more non-transitory, computer-readable media of claim 16, wherein the plurality of neural radiance fields are used to generate depth estimates for training scene images, the training scene images and the depth estimates are combined with synthetic images and depth estimates into a full set of training images and depths, and wherein a foundation model transforms the full set of training images and depths into the training data.

18. The one or more non-transitory, computer-readable media of claim 11, wherein the feature angles and depths are subsequently aggregated into the plurality of predicted feature maps via a ray marching procedure applied to a plurality of importance-sampled points.

19. The one or more non-transitory, computer-readable media of claim 11, wherein decoding the plurality of predicted feature maps comprises applying one or more supplemental transformations to the plurality of predicted feature maps to generate the plurality of final feature maps.

20. A computer system, comprising:
one or more memories storing instructions; and
one or more processors that are coupled to the one or more memories and, when executing the instructions, are configured to perform the steps of:
extracting feature information from a plurality of scene images,
encoding the feature information to generate a plurality of feature images,
estimating depths of at least a plurality of pixels in each feature image included in the plurality of feature images to produce a plurality of feature frustra,
generating a plurality of octree voxels from the plurality of feature frusta,
sampling points along a plurality of views from different proposed camera angles relative to the plurality of octree voxels to produce feature angles and depths,
aggregating the feature angles and depths to produce a plurality of predicted feature maps, and
decoding the plurality of predicted feature maps to generate a plurality of final features maps.
